(19) United States
(12) Patent Application Publication
(10) Pub. No.: US 2013/0332222 A1
(43) Pub. Date: Dec. 12, 2013

(54) COMPUTER-IMPLEMENTED SYSTEM AND METHOD FOR GENERATING A TACTICAL PLAN FOR RETAIL INVENTORY PLACEMENT WITH AUTOMATED FORECASTS

(71) Applicant: Marc Bourgeois, Guelph (CA)

(72) Inventor: Marc Bourgeois, Guelph (CA)

(21) Appl. No.: 13/885,492

(22) PCT Filed: Nov. 15, 2011
(86) PCT No.: PCT/CA2011/001258

§ 371 Date: Jul. 30, 2013

Related U.S. Application Data
(60) Provisional application No. 61/413,639, filed on Nov. 15, 2010.

(51) Int. Cl. G06Q 10/06; G06Q 10/08

(52) U.S. Cl. CPC G06Q 10/06315; G06Q 10/087
USPC 705/7.25

(57) ABSTRACT

There is disclosed a computer-implemented system and method for generating a merchandising standard with automated sales volume forecasts. In an embodiment, there is provided a computer-implemented method for generating a tactical plan for placement of product inventory in a retail environment, comprising: (i) selecting a merchandising standard for a product in a given reseller location, channel, or retail format; (ii) in dependence upon the selected merchandising standard and historical sales data accessed from an historical sales database, automatically calculating channel a sales forecast; (iii) comparing the automatically calculated sales forecast with actual sales of the product for the selected merchandising standard; and (iv) in dependence upon the difference between the automatically calculated sales forecast and the actual sales, providing a feedback signal to modify the tactical plan for placement of the product inventory. In an embodiment, the method further comprises accessing the historic sales data from a plurality of historical sales databases relevant to the reseller location, channel, or retail format.

### CROSS-REFERENCE TO RELATED APPLICATIONS

The present application claims the benefit of U.S. Provisional Application No. 61/413,639 filed on Nov. 15, 2010.

### FIELD

The present disclosure relates to a computer-implemented system and method for generating a tactical plan for placement of product inventory such as consumer packaged goods (CPG) in a retail environment, with automated forecasts.

### BACKGROUND

Every day, product and service vendors and resellers are faced with the same challenge: how to meet or exceed sales targets established in marketing campaign plans to maximize sales and profits for their product or service brands. The competitive nature of business dictates that they must secure the best placement of their products and/or service advertisements to survive.

As an example, the means of meeting or exceeding sales targets is driven by a brand's ability to influence retailers to support a particular campaign with tactical executions, such as temporary displays to push incremental product inventory into stores, along with point of sale communication that explains the campaign to the consumer in these stores. Equally important is the ability to create greater pull of inventory by securing the best locations in stores. The tactical plan to secure placement of inventory is known as a “merchandising standard”, which is essentially the prescriptive means by which a company plans to secure the right amount of sales by placing inventory in the best locations of the right stores on a specific display tool.

Inventory goals are generally established based on a planned number of tactical executions (i.e., placements) of displays multiplied by inventory on the display multiplied by the number of stores (the sales execution plan), and securing this incremental inventory is a key factor in the final campaign results. Additionally, the location of the display will have a direct impact on the rate at which inventory turns (is purchased), based on sheer customer traffic clusters. In most cases, a faster turning display will result in the display being restocked, which will result in even greater sales.

The measure of success against sales execution plans is commonly referred to as retail sales compliance, which is the difference between the actual sales and the sales predicted by an execution plan; or, said another way, the compliance against the merchandising standard planned for the specific marketing campaign.

Considering there are potentially thousands of retail stores across dozens of retail banners in several channels, the impact, and consequently the difficulty, of increasing brand inventory in the right stores in the best locations is clear. Assuming that increasing compliance of marketing plans will deliver increased sales volume via increased inventory distribution, and knowing that affecting thousands of stores requires the efforts of hundreds of employees, the importance of clear communication of these plans is arguably as important as the development of the marketing plans.

Although this “macro summary” of total volume is the typical measurement of success, it is widely understood that it is the sum of thousands of smaller “micro efforts” that will drive success up to the big-picture macro level. However, heretofore, no technology existed that enabled micro store-by-store merchandising standard development. Therefore, prior art methods of communicating these marketing campaign plans are limited by the lack of ability to customize and as a result are more homogenous.

While vendors currently have the ability to analyze and develop detailed sales plans in programs such as Microsoft™ Excel™ starting at a micro level, their resources are simply not big enough to manually generate sales plans that match the data-driven plans with prescriptive merchandising standards for every store type. Additionally, the current methods of planning and communicating merchandising standards are not effective or efficient. Communication of these standards are defaulted to static printouts and are more directional and high level than specific to region, retail banner, or to the individual store.

Therefore, although vendors can provide very high level macro direction against merchandising standards along with a detailed spreadsheet-generated forecast, the time it would take to generate specific and customized merchandising standards along with a turnkey sales forecast that reflects this merchandising standard for thousands of stores is simply not realistic as it would simply require too much time and resources to manually implement even though it would be highly beneficial to the business.

What is required, therefore, is an improved system and method for generating a tactical plan for inventory placement in a retail environment with automated forecasts.

### SUMMARY

The present disclosure relates to a computer-implemented system, method and computer program for generating a tactical plan for product placement in a retail environment with automated forecasts.

In an embodiment, there is provided a computer-implemented method for generating a tactical plan for placement of product inventory in a retail environment, comprising: (i) selecting a merchandising standard for a product in a given reseller location, channel, or retail format; (ii) in dependence upon the selected merchandising standard and historical sales data accessed from an historical sales database, automatically calculating a sales forecast; (iii) comparing the automatically calculated sales forecast with actual sales of the product for the selected merchandising standard; and (iv) in dependence upon the difference between the automatically calculated sales forecast and the actual sales, providing a feedback signal to modify the merchandising standard for placement of the product inventory. In an embodiment, the method further comprises accessing the historic sales data from a plurality of historical sales databases relevant to the reseller location, channel, or retail format.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates an embodiment in which links are shown between the display database, reseller database and historical sales databases.

FIG. 2 illustrates an example of an embodiment wherein a vendor accesses the user interface utility from the vendor computer.

FIG. 3 illustrates another illustrative embodiment wherein a vendor accesses the user interface utility from the vendor computer.

FIG. 4 illustrates a system in accordance with an embodiment.

FIG. 5 illustrates a generic computer device that may provide a suitable operating environment for various embodiments.

### DETAILED DESCRIPTION

As noted above, the present disclosure relates to a computer-implemented system, method and computer program for generating a tactical plan for placement of product inventory (such as consumer packaged goods or CPG), in a retail environment with automated forecasts (e.g. for sales volumes).

In an embodiment, the system and method enables a vendor to access, through a trusted intermediary, historical sales data for a product by a reseller based on prior executed merchandising standards (i.e. tactical plans for product inventory placements). Normally, a vendor's system is prevented from directly accessing the historical sales data from a reseller's system as this data is typically held confidentially by the reseller in its sales database. However, with a trusted intermediary enabling secure integration of historical sales data owned by a reseller, a reseller may agree to provide historical sales data for access by a vendor to be used for tactical plans for inventory placement.

In an embodiment, the system and method further enables the automatic generation of a sales forecast based on the merchandising standard (i.e. the tactical plans for inventory placement) for products (e.g. CPG) in a particular retail environment. The present system and method allows a merchandising standard to be customized at a micro level, such as for each retail location of a reseller, thus improving sales directly at the micro level in order to improve the macro level sales goals for a product or service vendor.

In another embodiment, the system and method also provides means for communicating and selling products (e.g. CPG) in association with the merchandising standard.

Furthermore, while the present specification refers to a “vendor”, it should be understood that the system and method could be used by any interested party, including the reseller or a third party. It should also be understood that the historical sales data may be owned by a party other than a reseller, such as a market analysis firm, for example.

In an embodiment, a merchandising standard engine is operable to generate a merchandising standard or tactical plan for inventory placement of products (e.g. CPG) in a retail environment by applying historical sales data to the merchandising standard parameters based on selected displays and reseller locations and/or product placements.

The merchandising standard engine enables vendors, which target maximized sales, to leverage already existing (or to be developed) historical sales data of the reseller. The historical sales data provides information relating to the sales possible in particular reseller locations and placements within the particular reseller locations, for specific products. Thus, the merchandising standard generated by the merchandising standard engine is highly accurate. The reseller is incentivized to participate at least on the basis of increased sales in their locations, but also by enabling any of their vendors to maximize sales of all products.

In an embodiment, the merchandising standard or tactical plan for placement of product inventory (e.g. CPG) in a retail environment may be developed using a computer-implemented user interface accessible by the vendor. The computer-implemented user interface enables the vendor to select one or more particular reseller locations as well as specific placements within each of the one or more particular reseller locations. The historical sales data is already associated with the locations and placements at particular reseller locations, or can be modified and/or augmented by the locations and placements at particular reseller locations.

By way of example, the historical sales data associated with different reseller locations and placements of product inventory can be retained in a historical sales database, such that the merchandising standard engine can determine which reseller locations and which placements have been historically the most successful. The historical sales database may be searchable, such that all historical sales data collected by an organization can be accessed for reference.

In addition to information on reseller locations and inventory placement, the historical sales database may further contain information on related marketing initiatives made at the time of the inventory placement including, for example, digital selling tools, TV ads, radio ads, and links to brand web-sites and promotional micro-sites.

The historical sales database may be further include various levels of detail, including the retailer format (large or small), the channels, and even down to a specific reseller by their location, and inventory placement in a particular part of the reseller's location using a particular type of product display used.

Advantageously, the present system and method allows the generation of a tactical plan for placement of product inventory (e.g. CPGs) in a retail environment based on historical sales information which allows the production of an automated sales forecast based on historical sales. Consequently, rather than planning a campaign based on the typical top-down strategy of selecting a global sales target for a region, assigning sales targets to each type of channel, and trying to execute the plan, the present system and method can be used to quickly calculate the sales forecast at a micro level, from the bottom-up, based on the inventory placements at particular reseller locations, and by the channels or formats through which a product or service is distributed. Therefore, a campaign can now be planned at a micro level—that is of individual resellers, channels, or format—to determine how selecting certain merchandising standards with automated forecasts can be used to meet a global sales target for a region.

In an embodiment, the user interface may include a graphical user interface that is linked to an augmented reality engine that specifically provides an augmented reality environment for facilitating the development and presentation of a merchandising standard. The augmented reality engine may enable a vendor to select a particular type of product display, and virtually position the display in an augmented reality environment representative of a particular reseller's location. The placement of product inventory in a reseller's location may be linked to particular historical sales data at the reseller's location, or in other similar channels, to provide a more granular, micro level of accuracy for applying historical sales data to merchandising standard parameters to generate the merchandising standard. The augmented reality environment of a particular reseller location can be provided by the reseller, for example, as a model.

In another embodiment, as a merchandising standard is implemented, the system and method is configured to track the current sales of items placed in accordance with the merchandising standard to determine if the automated sales forecast is accurate. If there is a significant discrepancy between the automated sales forecast and the actual sales forecast, the difference may be used to modify the development of future merchandising standards. In addition, if certain merchandising standards implemented at certain reseller locations or through certain channels are performing better than the automated sales forecast, the present system and method may be adapted to dynamically change the suggested merchandising standard to try to reproduce the success of a certain merchandising standard through other similar locations, channels or formats.

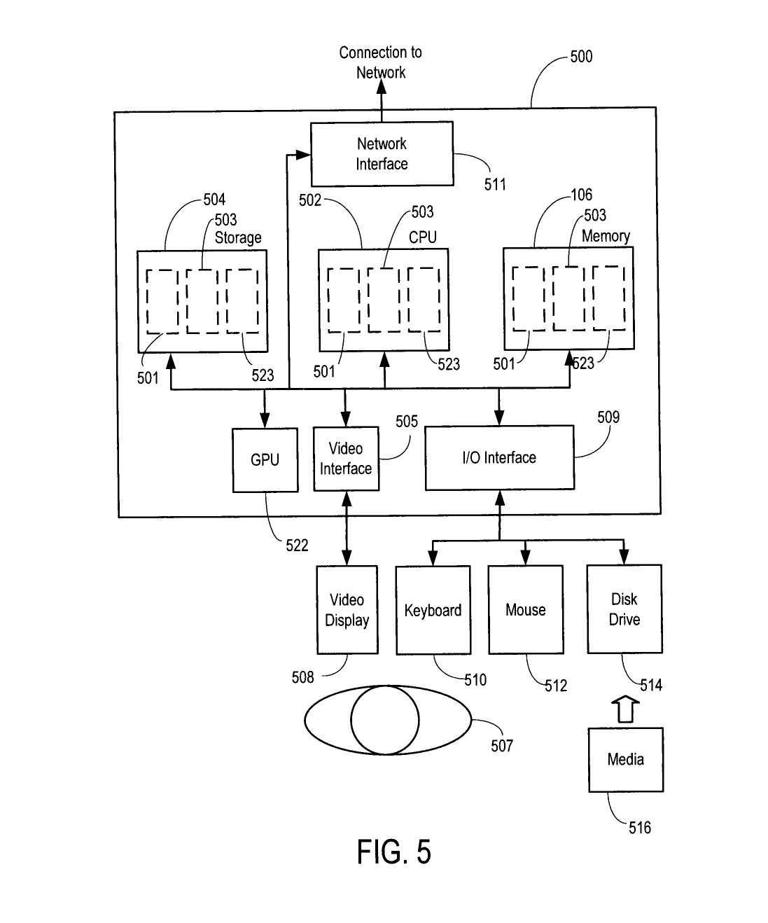

In an embodiment, the system and method may include a mobile computer device (such as is described further below with reference to FIG. 5) which allows communication with a field representative in a retail location. The mobile computer device may be a wireless mobile phone or a tablet, for example, which may be used to track and audit the actual product inventory placements and displays used at the reseller locations to confirm that the product display conforms to the planned merchandising standard. If the actual product placement is different from the planned product inventory placements as specified in the merchandising standard, then any difference between the estimated forecast and actual sales can be accounted for based on the variation from the specified merchandising standard.

In another embodiment, mobile computer devices can be used to provide real-time feedback of the effectiveness of a merchandising standard by confirming the actual sales versus the estimated forecast. As an illustrative example, CPGs displayed according to a specified merchandising standard may be monitored from the time of initial setup to track the number of items removed from a display, and subsequently restocked by a reseller. This may be done visually, or by automated tracking of the items, for example using radio-frequency identification (RFID) or some other means of sensing and tracking items using near-field communications.

By monitoring and reporting the actual sales for a specified merchandising standard at a given reseller location, via a mobile computer device for example, the present system and method can determine whether the actual sales are significantly better than the estimated forecast, and if so, the present system and method can modify or change a recommended merchandising standard for particular reseller locations, channels or formats during the course of a campaign. The feedback from the mobile computer devices can be stored, for example, in the historical sales database to provide even more accurate models for forecasting sales using a given merchandising standard for a given channel, format, or specific reseller location and the type of display.

In another embodiment, the present system and method also provides for the ability to change a merchandising standard easily to accommodate any changes necessitated by the reseller. For example, a vendor may request implementation of a particular merchandising standard in a reseller's store but the reseller may refuse the request. In such a case, the vendor may need to select an alternative merchandising standard which may not be the most preferred, but which may nevertheless still provide a good alternative to the first merchandising standard.

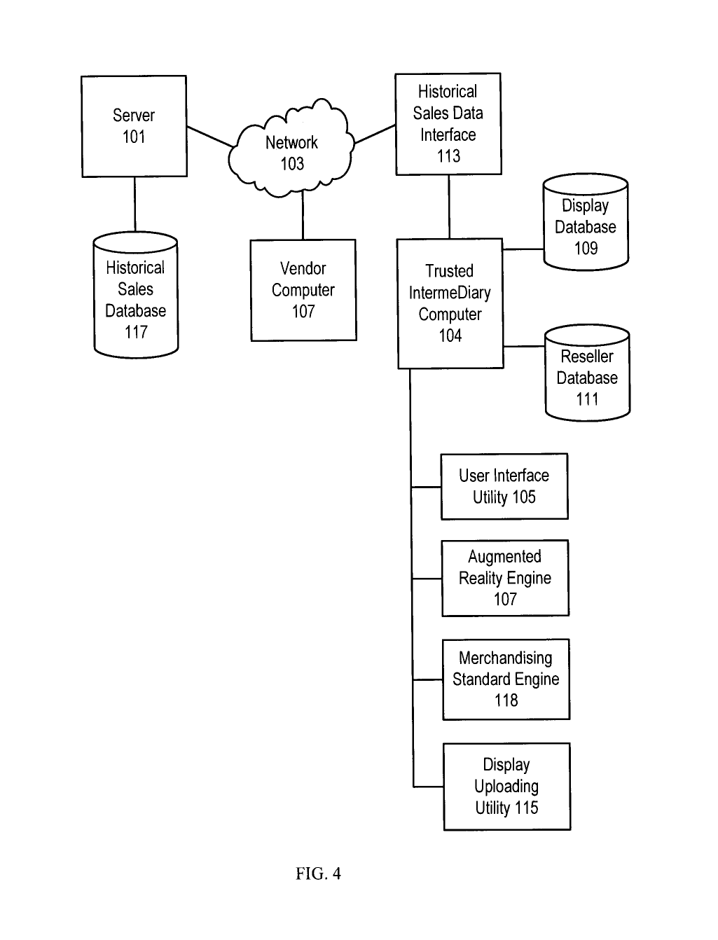

By way of example, an illustrative system will now be described with reference to FIG. 4. As shown in FIG. 4, one or more reseller owns or administers a server (101) (which could be embodied by one or more distributed computers) that is linked to a historical sales database (117). The server (101) is linked, by means of a network (103) such as the Internet, to a historical sales data interface (113), which is further linked to a trusted intermediary computer (104). A vendor communicates with the trusted intermediary computer (104) from a vendor computer (107) also linked to the network (103).

Still referring to FIG. 4, in an embodiment, historical sales data interface is operable to securely obtain historical sales data from the historical sales database. It should be understood that any number of resellers having similar environments can be linked to the trusted intermediary computer.

The historical sales database, for each reseller, may include records for each reseller location, including, for example: store name; unique store tracking number; geographical location of the store including store address, city, province, postal code, etc.; company assigned regional information of the store including region, zone, and district; retailer information of the store including channel and banner; and historical sales by SKU (stock keeping unit) and date/timeframe, including but not limited to unit sales, gross sales, net sales, and profit.

The trusted intermediary computer (104) includes or is linked to a merchandising standard engine (118) that is operable to provide a merchandising standard based on applying historical sales data to merchandising standard parameters based on the selected displays and the reseller locations and/or placements.

The trusted intermediary computer (104) includes or is linked to a user interface utility (105) that provides access to the trusted intermediary computer from the vendor computer (107). Alternatively, a user interface application could be installed on the vendor computer (107) or another computer linked to the vendor computer (107) for enabling access to the trusted intermediary computer (104). The user interface utility (105) may be linked to an augmented reality engine (107) for enabling graphical placement of displays in reseller location environments, which further facilitates more accurate generation of the merchandising standard by the merchandising standard engine.

The trusted intermediary computer (104) is also linked to: (i) a display database (109) that provides a database of selectable displays including merchandising standard parameters corresponding to the displays; (ii) a display uploading utility (115) enabling a vendor to provide displays to the display database; and (iii) a reseller database (111) that includes an index of resellers, reseller locations and/or placements within the reseller locations.

A suitably configured generic computer device that may be used for server (101), trusted intermediary computer (104), vendor computer (107), a mobile computer device or another type of computer device, and which may interact with the various components described above with respect to FIG. 4, is shown by way of example in FIG. 5. As shown, a generic computer device (500) includes a central processing unit (“CPU”) (502) connected to a storage unit (504) and to a random access memory (506). The CPU (502) may process an operating system (501), application program (503), and data (523). The operating system (501), application program (503), and data (523) may be stored in storage unit (504) and loaded into memory (506), as may be required. Computer device (500) may further include a graphics processing unit (GPU) (522) which is operatively connected to CPU (502) and to memory (506) to offload intensive image processing calculations from CPU (502) and run these calculations in parallel with CPU (502). An operator (507) may interact with the computer device (500) using a video display (508) connected by a video interface (505), and various input/output devices such as a keyboard (510), mouse (512), and disk drive or solid state drive (514) connected by an I/O interface (509). In known manner, the mouse (512) may be configured to control movement of a cursor in the video display (508), and to operate various graphical user interface (GUI) controls appearing in the video display (508) with a mouse button. The disk drive or solid state drive (514) may be configured to accept computer readable media (516). The computer device (500) may form part of a network via a network interface (511), allowing the computer device 500 to communicate with other suitably configured data processing systems (not shown). The network interface (511) may be configured for conventional wired or wireless network communications in known manner, using any one of a number of standard wired or wireless networking protocols.

The present system and method may be practiced on virtually any manner of computer device including a desktop computer, laptop computer, tablet computer or a wireless handheld computer device, all of which may be interconnected via a wired or wireless communications network. The present system and method may also be implemented as a computer-readable/useable medium that includes computer program code to enable one or more computer devices to implement each of the various process steps in a method in accordance with the present method and system. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

Referring back to FIG. 4, in an embodiment, the display database (119) includes merchandising standard parameters for each display. Merchandising standard parameters may include a display image depicting the display, display dimensions (length, width, height), brand (which may be a textual brand name and/or graphical brand identifier, including for example labelling, which may be provided in a known graphical format), brand product(s) (one or more SKUs, for example, by name, description and number) optionally including an image of the brand product, and inventory (the maximum amount of inventory for each brand product that can be held in the display). The brand product(s) may further include or be linked to further databases for providing product information such as pricing, cost, profit, etc. It should be understood that the display database may be provided by one or more linked relational databases, and could partly be provided by relational databases residing or owned by the vendor.

The reseller database (111) includes information on each reseller location, including by any one or more of the following: (i) country, region, state/province, district, county, city, town, neighbourhood, street, etc.; (ii) retail channel (for example, grocery, mass, drug, convenience, gas, hardware, liquor, gaming, electronics, etc.); and/or (iii) banner/brand. Each reseller location may further be associated with a transformer for modifying and/or augmenting the historical sales data for that location. This transformer is referred to herein as a “lift factor” that can be assigned based on research of the historical sales data, or may be included in the historical sales data. The reseller database may be a relational database linked relationally to the historical sales database. For example, the reseller database may provide a list of resellers, and obtain further more granular information directly from the historical sales database, if available.

The reseller database (111) may further include a model of each reseller location that may comprise dimensions, layouts, etc. for the location. The reseller location model may include one or more placement images, such as digital photographs, of the particular reseller location that can be used by the augmented reality engine to graphically represent the reseller location. The placement images can be linked to particular placements within the reseller location. For example, a plurality of digital photographs of the inside of a grocery store can be used to represent the full interior of the store, wherein each photograph is linked to placements based on each aisle, department, section, etc. of the store at a level of granularity that is reflective of the available historical sales data.

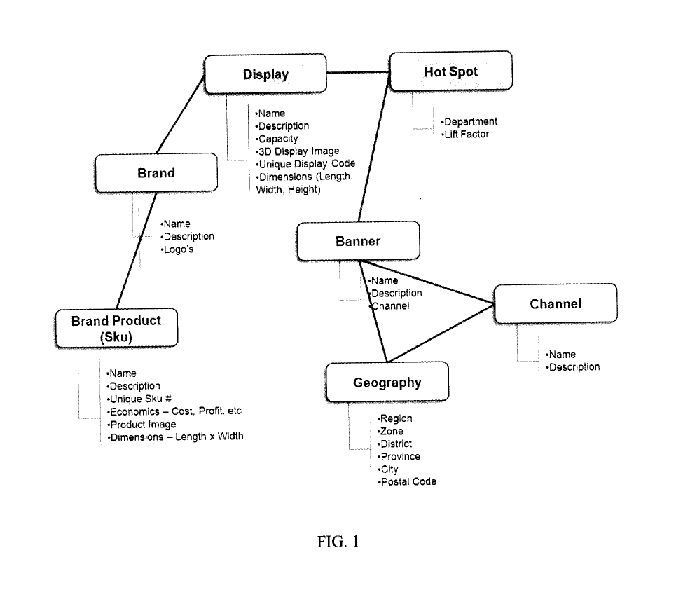

The display database (109), reseller database (111) and historical sales database (117) may be relational databases that are configured to comprise related fields so as to link the information contained therein in accordance with the present system and method. FIG. 1 illustrates links between the display database, reseller database and historical sales databases.

Where one or more reseller location models are provided, the display dimensions for a display enable the vendor to manually place a display within the reseller location by means of the augmented reality engine. If a reseller location model includes dimensions, then the augmented reality engine may use the reseller location model dimensions and the display dimensions to automatically scale the display within the reseller location model. Alternatively, the user interface utility may provide a control for the vendor to manually scale the display within the reseller location model.

The user interface utility may enable the vendor to search and/or browse reseller locations and/or displays by any of the reseller information and merchandising standard parameters available. This can be provided by text entry fields, drop down selection boxes, and other controls known to those skilled in the art.

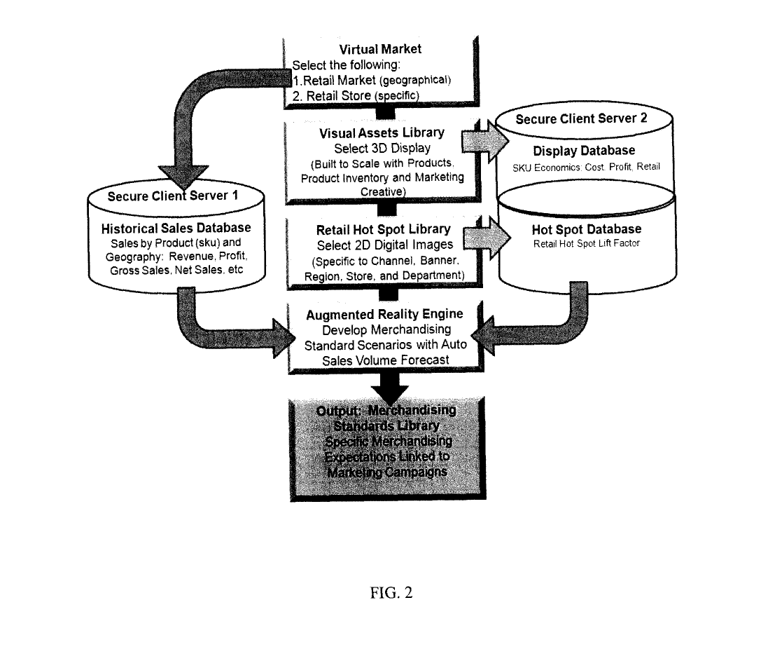

In an example of use, as shown in FIG. 2, the vendor accesses the user interface utility from the vendor computer. The vendor selects a particular display, and places the display in a particular placement of a particular reseller location using the augmented reality engine. The vendor requests, by means of a control provided by the user interface utility, a merchandising standard. The merchandising standard engine then accesses historical sales data that is applicable to the particular merchandising standard parameters, including the particular brand products and the particular placement, to generate a merchandising standard.

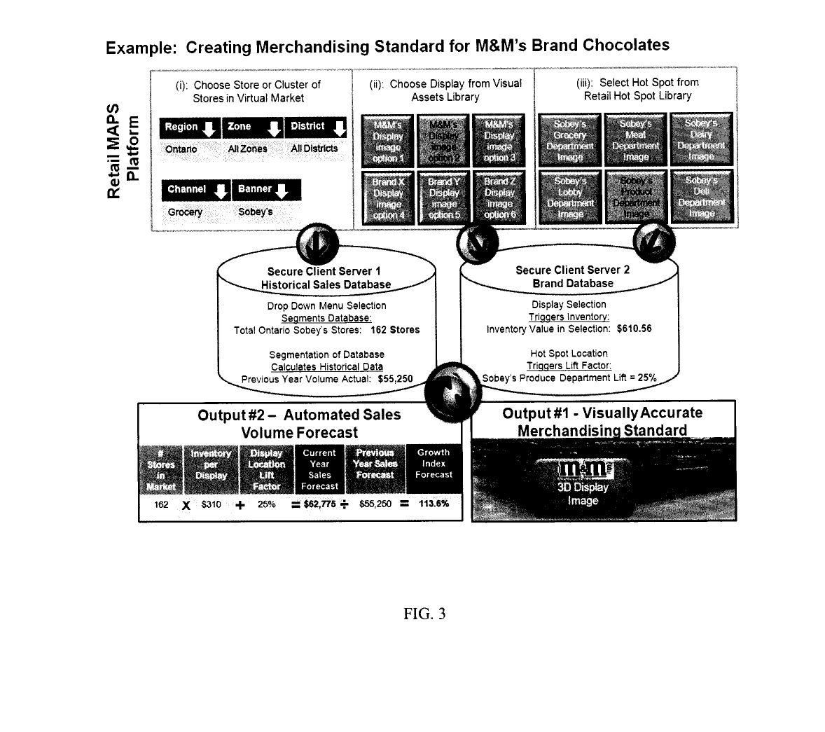

In a more detailed example, as shown in FIG. 3, a vendor accesses the user interface utility from the vendor computer. The vendor selects a reseller location by region, zone, district, channel and banner. In this particular example the region is Ontario, all zones, all districts, grocery channel and Sobey's™ banner.

The merchandising standard engine segments the data in the historical sales database based on the selected reseller location.

Once the reseller location has been selected, the vendor selects a particular display. The vendor can browse all displays by display image, brand name, brand labelling, or brand product. In this particular example, the vendor selects an M&M's™ display based on its display image.

The augmented reality engine enables the vendor to select a particular placement within the already selected reseller location by providing the vendor with a representation of the placement images provided for that reseller location, each of the placement images being linked to a particular placement within the reseller location. The vendor can, therefore, select the placement by navigating the reseller location in augmented reality to select the placement image that most closely represents a placement desired by the vendor. In this particular example, the vendor selects a placement image corresponding to the produce department of the selected Sobey's. The vendor can place the display within the placement by means of the augmented reality engine.

The vendor then requests, by means of a control provided by the user interface utility, a merchandising standard. The merchandising standard engine then accesses historical sales data that is applicable to the placement and the display to generate a merchandising standard. The vendor can also manipulate the display within placement using the augmented reality engine to create a high level of believability and an accurate depiction of what the merchandising standard looks like.

The vendor can repeat this process for any number of stores across any number of resellers.

The merchandising standard also generates automated sales forecasting. The merchandising standard engine is operable to determine a realistic sales forecast based on the display and the placement, for example using the following formula:

Sales Forecast=Total number of Stores×Total Inventory in Store×Inventory Economics

Inventory Economics may include any of the financial factors associated with SKU×the total number of SKUs on a particular display×lift factor×time in store. These financial factors include: unit cost, unit profits, unit retail price, average turns, etc.

The user interface utility may be operable to display the sales forecast textually, tabularly and/or graphically to the vendor. The vendor may also be provided means to save, export and/or disseminate the merchandising standard and sales forecast. For example, the merchandising standard may be exportable as an image, including as an image of the display located in a particular reseller location, enabling enhanced communication.

In another example of use, a vendor may be interested in creating a merchandising standard for a specific Sobey's store in Ontario and wants to understand the inventory unit growth as a result of this new proposed merchandising standard. After selecting this from the user interface utility, the historical sales data base is triggered. Once a display image is selected and placed into a specific Sobey's location using a model of the location, the sales forecast can be generated based on the following:
Sales Forecast based on merchandising standard=Y×I×U×L×T, where:
Total number of stores: Y (total sales are stored in the Historical Sales Database
Total Inventory in store: I (inventory is stored in the Display Database)
Inventory Economics: U (unit cost)/P (unit profit)/R (retail sales)
Lift Factor: L (lift factor is stored in the Display Database and is linked to the store image selected)
Time in store: T (the user selects the time in store in the user interface)

The historical sales database provides the forecasted growth by comparing the merchandising standard's forecast for incremental unit inventory versus the actual unit inventory in the same store and by comparing the forecasted sales as a result of the proposed merchandising standard versus the actual sales during the same time period one year prior, for example.

The formula for calculating the growth potential as a result of the merchandising standard is: Forecast divided by Actual=growth percentage.

Thus, the present system and method enables, firstly, greater comprehension and understanding of the merchandising standard, leading to greater execution and higher compliance of stores authorizing the implementation of the merchandising standard. This is based on the widely held assumption that providing an accurate visual that clearly depicts the change that is being proposed will lead to a greater understanding of it, and therefore higher success against implementing the merchandising standard.

Secondly, the present system and method enables generation of a sales forecast automatically based on a generated merchandising standard, so that retailers are able to quickly assess the viability of a proposed change.

Thirdly, the present system and method provides an efficient means of communicating merchandising standards. Since the present system and method utilizes accurate visuals to develop and depict the merchandising standard, and since each of these images can be exported as an image to be easily shared, a merchandising standard image can therefore be utilized in many standard vendor communication platforms such as in digital presentations. This enables custom presentations featuring accurate and detailed merchandising standards that can be presented both internally to vendor sales and marketing teams and externally to retailers, a task which is currently next to impossible or at the very least, highly time consuming and inefficient.

Thus, in an aspect, there is provided a computer-implemented method for generating a tactical plan for placement of product inventory in a retail environment, comprising: (i) selecting a merchandising standard for a product in a given reseller location, channel, or retail format; (ii) in dependence upon the selected merchandising standard and historical sales data accessed from an historical sales database, automatically calculating a sales forecast; (iii) comparing the automatically calculated sales forecast with actual sales of the product for the selected merchandising standard; and (iv) in dependence upon the difference between the automatically calculated sales forecast and the actual sales, providing a feedback signal to modify the tactical plan for placement of the product inventory.

In an embodiment, the method further comprises accessing the historic sales data from a plurality of historical sales databases relevant to the reseller location, channel, or retail format.

In another embodiment, the method further comprises accessing historical sales data from a reseller's system through a trusted intermediary, such that historical sales data owned by a reseller is accessible to a vendor on a secure basis.

In another embodiment, the method further comprises displaying on a graphical display the selected merchandising standard, such that the merchandising standard can be specifically adopted for a given reseller's location, channel, or retail format.

In another embodiment, the method further comprises displaying on a graphical display one or more merchandising standards, including a display image depicting the display and display dimensions including length, width, height.

In another embodiment, the method further comprises displaying on a graphical display one or more merchandising standards, including the product brand, an image of the product, and the maximum amount product inventory that can be held in the display.

In another embodiment, a reseller database includes information on each reseller location, retail channel, and brand, and the method further comprises modifying and augmenting the historical sales data for that location in a historical sales database.

In another embodiment, the reseller database provides a list of resellers, and the method further comprises obtaining information directly from the historical sales databases for each of the resellers, if available.

In another embodiment, the reseller database further includes a virtual model of each reseller location including dimensions and layouts, and the method further comprises visually displaying on a graphical display one or more merchandising standards within the context of the virtual model of each reseller location.

In another embodiment, the virtual model comprises a digital photograph of each reseller location, and the method further comprises placing a merchandising standard within the virtual model.

In another aspect, there is provided a computer-implemented system for generating a tactical plan for placement of product inventory in a retail environment, comprising: means for selecting a merchandising standard for a product in a given reseller location, channel, or retail format; means for automatically calculating a sales forecast in dependence upon the selected merchandising standard and historical sales data accessed from an historical sales database; means for comparing the automatically calculated sales forecast with actual sales of the product for the selected merchandising standard; and means for providing a feedback signal to modify the tactical plan for placement of the product inventory in dependence upon the difference between the automatically calculated sales forecast and the actual sales.

In an embodiment, the system further comprises means for accessing the historic sales data from a plurality of historical sales databases relevant to the reseller location, channel, or retail format.

In another embodiment, the system further comprises means for accessing historical sales data from a reseller's system through a trusted intermediary, such that historical sales data owned by a reseller is accessible to a vendor on a secure basis.

In another embodiment, the system further comprises means for displaying on a graphical display the selected merchandising standard, such that the merchandising standard can be specifically adopted for a given reseller's location, channel, or retail format.

In another embodiment, the system further comprises means for displaying on a graphical display one or more merchandising standards, including a display image depicting the display and display dimensions including length, width, height.

In another embodiment, the system further comprises means for displaying on a graphical display one or more merchandising standards, including the product brand, an image of the product, and the maximum amount product inventory that can be held in the display.

In another embodiment, a reseller database includes information on each reseller location, retail channel, and brand, and the system further comprises means for modifying and augmenting the historical sales data for that location in a historical sales database.

In another embodiment, the reseller database provides a list of resellers, and the system further comprises means for obtaining information directly from the historical sales databases for each of the resellers, if available.

In another embodiment, the reseller database further includes a virtual model of each reseller location including dimensions and layouts, and the system further comprises means for visually displaying on a graphical display one or more merchandising standards within the context of the virtual model of each reseller location.

In another embodiment, the virtual model comprises a digital photograph of each reseller location, and the system further comprises means for placing a merchandising standard within the virtual model.

While various embodiments have been described above by way of illustration, the scope of the invention is defined by the following claims.

1. A computer-implemented method for generating a tactical plan for placement of product inventory in a retail environment, comprising:
(i) selecting a merchandising standard for a product in a given reseller location, channel, or retail format;
(ii) in dependence upon the selected merchandising standard and historical sales data accessed from an historical sales database, automatically calculating a sales forecast;
(iii) comparing the automatically calculated sales forecast with actual sales of the product for the selected merchandising standard; and
(iv) in dependence upon the difference between the automatically calculated sales forecast and the actual sales, providing a feedback signal to modify the tactical plan for placement of the product inventory.

2. The method of claim 1, further comprising accessing the historic sales data from a plurality of historical sales databases relevant to the reseller location, channel, or retail format.

3. The method of claim 2, further comprising accessing historical sales data from a reseller's system through a trusted intermediary, such that historical sales data owned by a reseller is accessible to a vendor on a secure basis.

4. The method of claim 1, further comprising displaying on a graphical display the selected merchandising standard, such that the merchandising standard can be specifically adopted for a given reseller's location, channel, or retail format.

5. The method of claim 4, further comprising displaying on a graphical display one or more merchandising standards, including a display image depicting the display and display dimensions including length, width, height.

6. The method of claim 4, further comprising displaying on a graphical display one or more merchandising standards, including the product brand, an image of the product, and the maximum amount product inventory that can be held in the display.

7. The method of claim 1, wherein a reseller database includes information on each reseller location, retail channel, and brand, and the method further comprises modifying and augmenting the historical sales data for that location in a historical sales database.

8. The method of claim 7, wherein the reseller database provides a list of resellers, and the method further comprises obtaining information directly from the historical sales databases for each of the resellers, if available.

9. The method of claim 8, wherein the reseller database further includes a virtual model of each reseller location including dimensions and layouts, and the method further comprises visually displaying on a graphical display one or more merchandising standards within the context of the virtual model of each reseller location.

10. The method of claim 9, wherein the virtual model comprises a digital photograph of each reseller location, and the method further comprises placing a merchandising standard within the virtual model.

11. A computer-implemented system for generating a tactical plan for placement of product inventory in a retail environment, comprising:
means for selecting a merchandising standard for a product in a given reseller location, channel, or retail format;
means for automatically calculating a sales forecast in dependence upon the selected merchandising standard and historical sales data accessed from an historical sales database;
means for comparing the automatically calculated sales forecast with actual sales of the product for the selected merchandising standard; and
means for providing a feedback signal to modify the tactical plan for placement of the product inventory in dependence upon the difference between the automatically calculated sales forecast and the actual sales.

12. The system of claim 11, further comprising means for accessing the historic sales data from a plurality of historical sales databases relevant to the reseller location, channel, or retail format.

13. The system of claim 12, further comprising means for accessing historical sales data from a reseller's system through a trusted intermediary, such that historical sales data owned by a reseller is accessible to a vendor on a secure basis.

14. The system of claim 11, further comprising means for displaying on a graphical display the selected merchandising standard, such that the merchandising standard can be specifically adopted for a given reseller's location, channel, or retail format.

15. The system of claim 14, further comprising means for displaying on a graphical display one or more merchandising standards, including a display image depicting the display and display dimensions including length, width, height.

16. The system of claim 14, further comprising means for displaying on a graphical display one or more merchandising standards, including the product brand, an image of the product, and the maximum amount product inventory that can be held in the display.

17. The system of claim 11, wherein a reseller database includes information on each reseller location, retail channel, and brand, and the system further comprises means for modifying and augmenting the historical sales data for that location in a historical sales database.

18. The system of claim 17, wherein the reseller database provides a list of resellers, and the system further comprises means for obtaining information directly from the historical sales databases for each of the resellers, if available.

19. The system of claim 18, wherein the reseller database further includes a virtual model of each reseller location including dimensions and layouts, and the system further comprises means for visually displaying on a graphical display one or more merchandising standards within the context of the virtual model of each reseller location.

20. The system of claim 19, wherein the virtual model comprises a digital photograph of each reseller location, and the system further comprises means for placing a merchandising standard within the virtual model.
